(19) United States
(12) Patent Application Publication
(10) Pub. No.: US 2004/0050607 A1
(43) Pub. Date: Mar. 18, 2004

(54) Body-mountable vehicle safety escape apparatus

(76) Inventor: Douglas Souther, Phoenix, AZ (US)

Correspondence Address: Steven Thrasher, 391 Sandhill Dr., Richardson, TX, 75080, US

(21) Appl. No.: 10/244,213

(22) Filed: Sep. 16, 2002

(51) Int. Cl. B60R 21/00

(52) U.S. Cl. 180/271

(57) ABSTRACT

The invention provides vehicle window-shattering (or dicing) systems and apparatuses that enable a vehicle occupant to escape a vehicle in the event of an emergency, particularly when a door or other means of escape is inoperable or undesirable. One embodiment of the invention is a system for dicing vehicle glass that provides a user interface, a propulsion system, and a vehicle glass-dicing tip whereby the propulsion system enables the tip to impact a vehicle window with a force sufficient to dice or shatter the vehicle window.

### RELATED APPLICATIONS

The present Non-Provisional Patent Application relates to co-filed and co-pending U.S. patent application Ser. No. 10/______ entitled VEHICLE SAFETY ESCAPE APPARATUS by MacDougall, et al., filed on Sep. 13, 2002.

### FIELD OF THE INVENTION

The invention relates to safety systems and apparatuses for shattering glass to facilitate escape from a vehicle, and, more particularly, the invention relates to body-mountable systems and apparatuses that enable the shattering of vehicle glass.

### PROBLEM STATEMENT

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

Discussion

Persons may become trapped in a vehicle due to a wide variety of circumstances. During flood conditions, sometimes a person will try to drive through water in a flooded street or depression without realizing how deep the water is or how fast a current is moving. Sometimes, due to poor driving or to poor road conditions, a person will drive a car into a body of water, such as a reservoir or a lake, thereby trapping the occupants of the vehicle inside. In yet other circumstances a vehicle occupant may be trapped inside a car during a wreck. Occasionally, vehicles in a wreck catch on fire and burn any occupants who are trapped inside. Whether due to fire, flood, or other trapping, vehicle occupants need a means for escape in the event they are trapped inside and face potential danger.

Unfortunately, doors are frequently jammed shut in emergency situations such as fires, floods, or wrecks. Therefore, an occupant of the vehicle cannot simply open a door and escape. In addition, since systems are often inoperative in such emergency situations, power windows cannot be opened. Furthermore, even if power systems do work or even if mechanical systems are operable, the windows are also frequently jammed shut or do not completely/sufficiently open.

When the doors and windows are both jammed in an emergency situation, it is necessary to shatter a window so that the occupants can escape. Tools that shatter vehicle glass exist, but these tools suffer the disadvantages of requiring a potential user to store the tool close to them (typically the driver's seat), and, to operate, requiring a user to be able to access the tool, remove the tool from storage, and then have the freedom of movement required to swing the tool with sufficient force to break the vehicle glass. Unfortunately, few persons have the foresight to properly store, and the presence of mind in an accident to properly use, the tool. Thus, it is desirous to provide a vehicle window-shattering tool that is effective and easily used in an emergency. The present invention provides such systems and devices.

### SELECTED OVERVIEW OF SELECTED EMBODIMENTS

The invention provides technical advantages as systems and apparatuses that enable the shattering (or dicing) of a vehicle window. One vehicle window dicing system provides a user interface, a propulsion system, and a vehicle glass-dicing tip. Generally, the propulsion system enables a tip to impact a vehicle window with a force sufficient to dice the vehicle window. Preferably, the tip is sufficiently hard and shaped to enable the shattering of a pane of glass. Accordingly, the invention provides advantages over the prior art as an accessible and effective window-dicing means that enables a vehicle occupant to escape in the event of an emergency.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention and it should be understood that the invention is not limited by the detailed description. Accordingly, the invention should be read as being limited only by the claims.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings, in which:

FIG. 1 is a block-diagram of the invention;

FIG. 2 illustrates the invention as a stand-alone system;

FIG. 3 shows an alternative embodiment of the invention mounted in a vehicle door; and

FIG. 4 teaches an alternative embodiment of the invention that automatically dices a vehicle window upon the detection of a predetermined water pressure.

### EXEMPLARY EMBODIMENT OF A BEST MODE

Introduction

The invention provides vehicle window-shattering (or dicing) systems and apparatuses that allow vehicle occupants to escape a vehicle, particularly when a door or other means of escape is inoperable, such as in an emergency. One vehicle window dicing system provides a user interface, and a propulsion system that enables a tip to impact a vehicle window with a force sufficient to dice the vehicle window.

Interpretation Considerations

When reading this section (An Exemplary Embodiment of a Best Mode, which describes an exemplary embodiment of the best mode of the invention, hereinafter “exemplary embodiment” ), one should keep in mind several tips. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment. Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in 112, paragraph 6 of 35 U.S.C., unless used as “means for functioning—” or “step” for —functioning—“in the Claims section.

Exemplary Devices and Systems

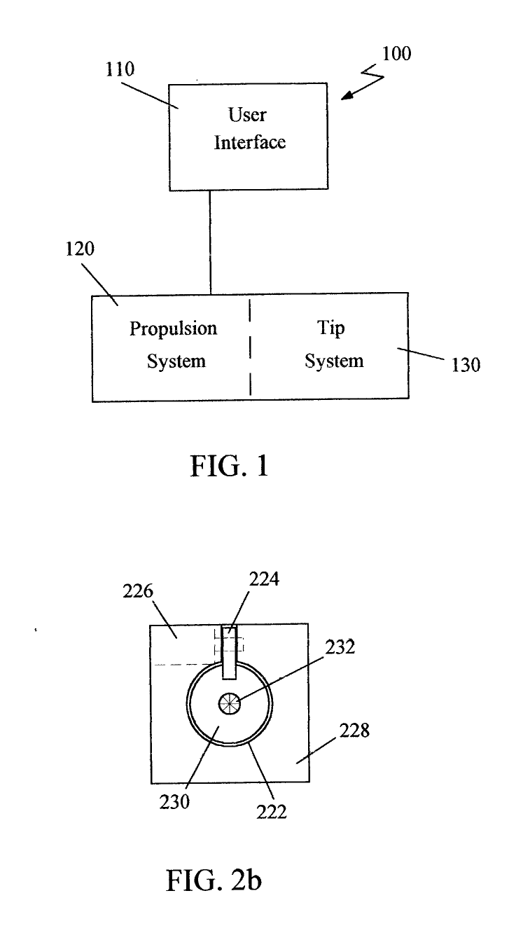

In one embodiment, the invention provides systems that enable an occupant to escape a vehicle. FIG. 1 is a block-diagram of the invention embodied as a system for dicing vehicle glass (the system) 100. The system 100 includes a user interface 110, a propulsion system 120 in communication with the user interfacel 10, and a vehicle glass dicing tip system (the tip system) 130. The user interface can be any means that enables a user to actively or passively order a window to be diced. For example, the user interface 110 may provide a button for activation, or by means that require no action by vehicle occupants, such as detecting that a person's biorhythms are behaving in a manner that indicate the person needs to immediately exit a vehicle. In some alternative embodiments, the user interface 110 is optional and the process of dicing a vehicle window is initiated via other means, as discussed below.

The propulsion system 120 is any means that enables the tip system 130 to impact into a vehicle window with a force sufficient to dice the vehicle window. Generally, this means that the propulsion system 120 includes means for propelling the tip system 130, as well as means for guiding the tip system 130. However, it should be understood that in some alternative embodiments means for propelling is provided by a user or other device, and the propulsion system 120 merely channels energy to the tip system 130, and thus to a vehicle window. The tip system 130 is any system of devices capable of dicing a vehicle window (meaning that the generally sound and uniformly transparent state of the window is altered to a generally fractured state that enables a window to be easily (if only partially) removed from an automobile window seal).

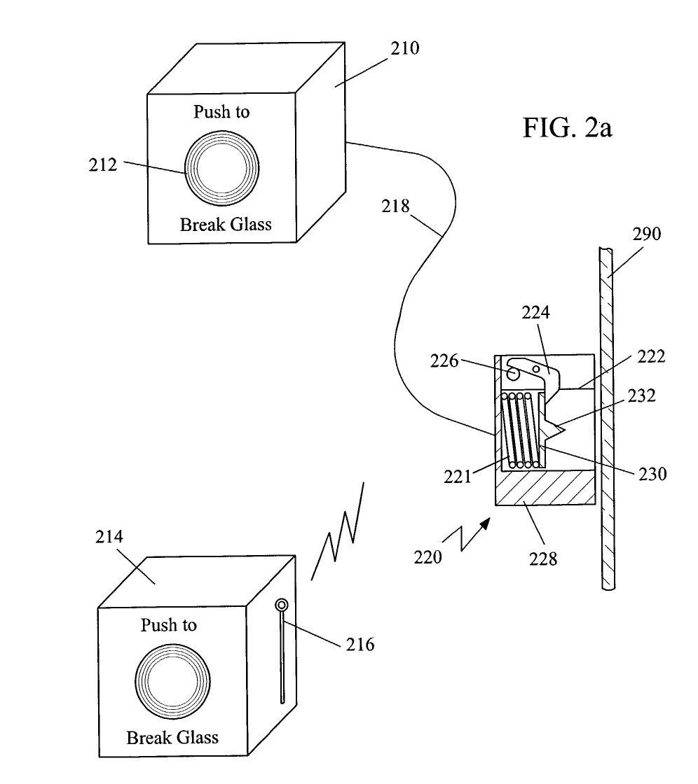

Better understanding of the invention can be gained by viewing a more specific embodiment. Accordingly, FIG. 2 illustrates the invention as a stand-alone system 200, including a user-interface 210 having a user-activated button 212, while FIG. 2B provides a top view of the container 228 having a propulsion system 220 and a tip system 230 therein. This and other embodiments of the user interface 210 which are known in the art allow the user interface 210 to be coupled to a steering wheel, a vehicle door, a glove box, or other vehicle surface (not shown). Notice that the container abuts the vehicle glass 290, and although illustrated generally as a rectangle, may be any shape capable of achieving the functions described herein.

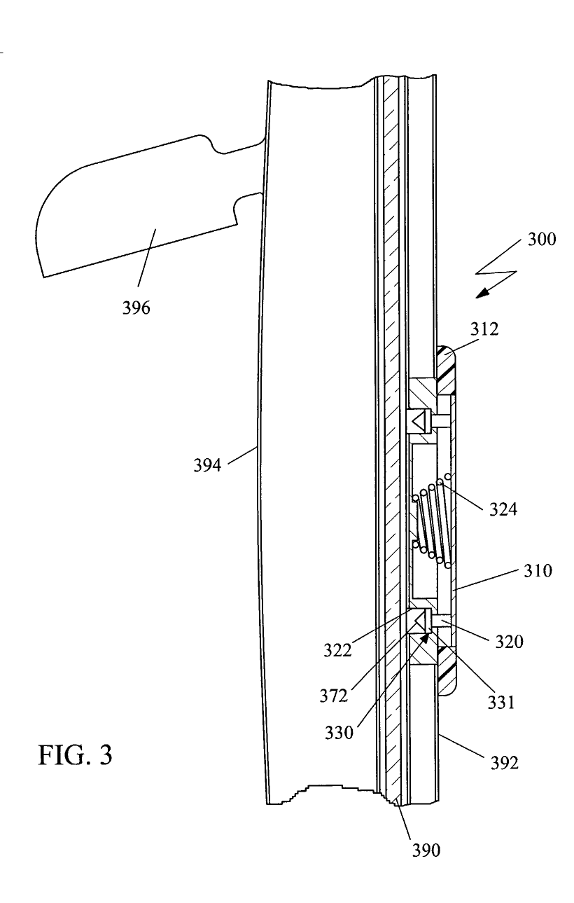

In FIG. 2, the user interface 210 is coupled to a propulsion system 220 via wire 218, while a second user interface 214 uses an antenna 216 to communicate with the propulsion system 220 via a radio wave (illustrated by the thunderbolt). The propulsion system 220 provides mechanical energy through a spring 221, which is preferably factory-set in a position that stores sufficient mechanical energy to propel a tip system 230 with sufficient force to dice or shatter a vehicle window 290. Of course, although the spring 221 is illustrated, to provide the force needed to dice or shatter a vehicle window, the propulsion system could use any system for delivering a mechanical force, such as a hand punch (see FIG. 3), a compressed-air container, or a material that quickly expands as a gas when heated, for example. The propulsion system 220 also includes a guide 222 that controls the direction of movement of the tip system 130 towards a vehicle window 190.

Accordingly, the guide assists with the delivery of the proper force, and in the proper direction, so that the vehicle window 190 can be shattered. To control the release of mechanical energy, the propulsion system 220 of FIG. 2 comprises an actuator 226 that releases a spring lock 224 from a position where the spring 221 is secured, to a position that releases the mechanical energy of the spring 221. Similarly, other actuators may be used to release mechanical energy in other systems, as is known in the art.

A tip system 230 (a “dicer”), generally includes a slug, such as a metal slug 321, and a tip 322. The tip comprises a material that is harder than glass, and is preferably carbide steel (the entire tip system may be made of a material that is harder than vehicle glass). In addition, the tip 322 may be of any shape capable of properly directing force at a vehicle window such that the vehicle shatters when an approximate predetermined force is applied, and, in one preferred embodiment, the tip is a point.

In addition to embodiments that actively apply a mechanical force, other alternative embodiments merely direct a human generated force. Accordingly, FIG. 3 shows an alternative embodiment of the invention mounted in a vehicle door, known as a door-mounted vehicle glass dicing apparatus (the dicing apparatus) 300. The dicing apparatus includes a user interface 310, a propulsion system 320 in communication with the user interface, a vehicle glass dicing tip system (the tip system) 330 coupled to the propulsion system 320 such that the propulsion system 320 enables the tip system 330 to impact into a vehicle window 390 with a force sufficient to dice the vehicle window 390.

In addition, the dicing apparatus 300 preferably includes an egression tool container 312 configured to fit into a vehicle door between an inside door 392 and a vehicle window 390, while simultaneously storing the tip system 320 and the propulsion system 330. Of course, the invention could easily be arranged to fit into the exterior sidewall 394 of the car (the sidewall is emphasized via the rear view mirror 396)—although such an embodiment is not shown, it is easily understood by one of ordinary skill in the art in light of the present discussion. Thus, the egression tool container 312 typically requires vehicle-specific design, and is thus preferably made via plastic molding (although, of course, other forms of manufacture are entirely permissible and known in the art of container manufacturing).

FIG. 3, the user interface 310 is an impact surface, meaning that the surface is preferably ergonomically designed to take a “punch” or other quick human-generated impact via foam or leather covering, for example. In addition, the impact surface 310 may include lettering such as “punch here to break glass” or other emergence message/reminder. A steady-state spring 324 coupled between the tip system 330 and the user interface 310 holds the user interface in a benign position gently enough such that when a predetermined force is applied to the user interface 310, the tip system impacts the vehicle glass 390 with sufficient force to shatter the vehicle glass 390. Although a spring 324 is shown here, of course, any mechanical item capable of performing the same function is interchangeable, such as a blown-up bag, a plastic stick(s), or mechanical diaphragm. Guide channels 322 form part of the propulsion system 320 and are used to guide the tip system 330 to the vehicle glass 390. Of course, although guide channels 322 are shown, many methods of mechanically guiding an object to a desired location are known, and the guide channels 322 although preferred, are exemplary.

The tip system 330 includes a slug 331 adapted to fit securely, yet movably in the channel guide 332. In addition, a tip 332 is disposed upon the slug 331. The tip 332 is enabled (via shape and hardness) to shatter the vehicle glass 390. In one embodiment, the tip 332 is generally a point, however, it should be understood that many shapes capable of shattering a window are readily apparent to one of ordinary skill in the art, and any shape capable of shattering a vehicle window is within the scope of the invention. In addition, the tip 332 is made of material that is harder than a pane of vehicle glass, and is preferably a carbide-based material, such as carbide-steel. However, many materials capable of shattering a window are readily apparent to one of ordinary skill in the art, and any material capable of shattering a vehicle window is also within the scope of the invention.

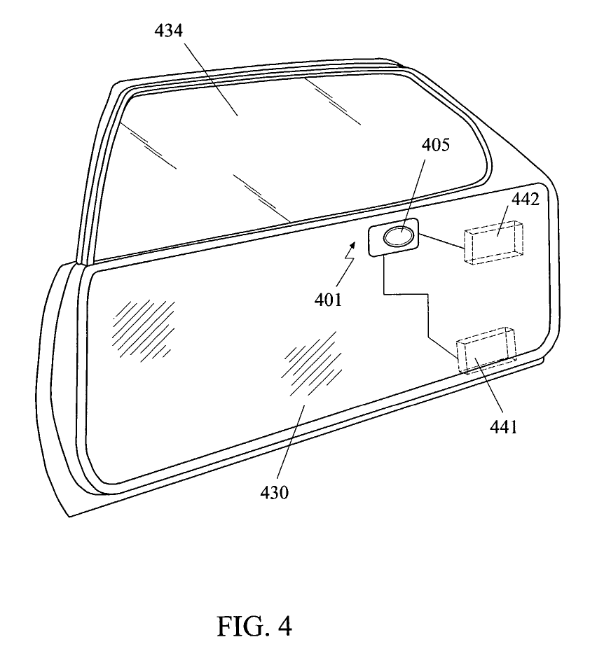

Other embodiments of the invention provide additional features and functionality. For example, FIG. 4 teaches an alternative embodiment of the invention that automatically dices a vehicle window upon the detection of a predetermined water pressure (the automatic system 400). The automatic system 400 typically includes a first water pressure detector 441 in communication with a propulsion system of a window dicing apparatus 401. The first water pressure detector 441 enables the window dicing apparatus 401 to operate when the first water pressure detector 441 detects a predetermined water pressure. This is accomplished, in part by the propulsion system that is coupled to the tip system in the window dicing apparatus such that the propulsion system enables the dicing of a vehicle window by the tip system. An additional feature provided by the window dicing apparatus 401 is a strobe light 405 that is mounted in the window dicing apparatus 401. In operation, when the first water pressure detector 441 detects a predetermined water pressure, the strobe light receives power and begins functioning by emitting strobes of light via a water resistant light source, such as an LED.

Additional functionality is provided to the present inventive embodiment via a second water pressure detector 442 that is coupled to the propulsion system of the window dicing apparatus 401. The second water pressure detector 442 automatically activates the propulsion system when the second water pressure detector 442 detects a second predetermined water pressure. Similarly, the first water pressure detector 441 may be enabled to detect multiple water pressures, in which case multiple water pressure detectors are unnecessary. In such a case, the window dicing apparatus 401 activates to dice a vehicle window 434 when the first water pressure detector 441 detects a second predetermined water pressure. Preferably, the first water pressure indicates a probable vehicle partial submersion, and a second water pressure indicates that it is likely that water is within a couple of feet of completely submerging the vehicle. Of course, multiple water pressure detectors can be mounted to account for front-submersion, rear-submersion, upside-down, and other submersion conditions.

Furthermore, it is understood that readily identifiable user interfaces may make the invention more useful. For example, a user interface may be a bright neon color, may include lights and light emitting diodes (LEDs) which may light upon water detection, or may provide a point-source identifiable audible sound to help a user locate the apparatus in the event of an emergency. Additionally, a user interface may also be located on the outside of a vehicle to enable a rescue worker or other person located outside of the vehicle to dice or shatter a window. It is understood that various readily identifiable means exist and will be developed for making bases more readily identifiable in the event of an emergency, and that these means are incorporated in the invention without departing from the scope of the invention.

Though the invention has been described with respect to a specific preferred embodiment, many variations and modifications will become apparent to those skilled in the art upon reading the present application. The appended claims are to be interpreted as broadly as possible in view of the prior art to include all such variations and modifications.

I claim:

1. A system for dicing vehicle glass (the system), comprising:
a user interface;
a propulsion system in communication with the user interface; and
a vehicle glass dicing tip system (the tip system) coupled to the propulsion system such that the propulsion system enables the tip system to impact into a vehicle window with a force sufficient to dice the vehicle window.

2. The system of claim 1, wherein the user interface is a button.

3. The system of claim 1, wherein the user interface is coupled to a steering wheel.

4. The system of claim 1, wherein the user interface is an impact surface.

5. The system of claim 1, wherein the user interface is integrated into a vehicle door.

6. The system of claim 1, wherein the user interface is provided in a vehicle glove-box.

7. The system of claim 1, wherein the user interface is in communication with the propulsion system via a radio-wave.

8. The system of claim 1, wherein the propulsion system comprises a spring.

9. The system of claim 1, wherein the propulsion system comprises a compressed-air container.

10. The system of claim 1, wherein the propulsion system comprises a material that quickly expands as a gas when heated.

11. The system of claim 1, wherein the tip system comprises a metal slug.

12. The system of claim 11, wherein the metal slug further comprises a carbide tip.

13. The system of claim 12, wherein the tip comprises a material that is harder than glass.

14. The system of claim 11, wherein the tip system comprises a material that is harder than glass.

15. The system of claim 14, wherein the tip comprises a point.

16. The system of claim 1, further comprising a steady-state spring coupled between the tip system and the user interface.

17. A system for dicing vehicle glass, comprising:
a first water pressure detector in communication with a propulsion system, the first water pressure detector enabling the propulsion system to operate when a predetermined water pressure is detected by the first water pressure detector; and
a tip system coupled to the propulsion system such that the propulsion system enables the dicing of a vehicle window by the tip system.

18. The system for dicing vehicle glass of claim 17 further comprising a second water pressure detector coupled to the propulsion system, the second water pressure detector automatically initiates the propulsion system when a second predetermined water pressure is detected by the second water pressure detected.

19. A door-mounted vehicle glass dicing apparatus, comprising:
a user interface;
a propulsion system in communication with the user interface;
a vehicle glass dicing tip system (the tip system) coupled to the propulsion system such that the propulsion system enables the tip system to impact into a vehicle window with a force sufficient to dice the vehicle window; and
an egression tool container configured to fit into a vehicle door, the egression tool container stores the tip system and the propulsion system.
